(19) United States
(12) Patent Application Publication
(10) Pub. No.: US 2026/0203613 A1
(43) Pub. Date: Jul. 16, 2026

(54) VALIDATING COMPLIANCE OF A COMPUTING SYSTEM WITH NATURAL LANGUAGE EXPRESSED POLICIES

(71) Applicant: International Business Machines Corporation, Armonk, NY (US)

(72) Inventors: Jingdong SUN, Rochester, MN (US); Frank Eduardo Chavez Malpartida, Dallas, TX (US); NEIL DELIMA, Scarborough (CA)

(21) Appl. No.: 19/020,132

(22) Filed: Jan. 14, 2025

(51) Int. Cl. G06N 5/025; G06F 8/41

(52) U.S. Cl. CPC G06N 5/025; G06F 8/41

(57) ABSTRACT

Mechanisms are provided to perform intelligent compliance verification for monitored computing environments. The mechanisms train a first artificial intelligence (AI) computer model to generate rules from natural language content, to thereby generate a first trained AI computer model. The mechanisms train a second AI computer model to verify compliance of a monitored computing environment with rules generated by the first AI computer model, to thereby generate a second trained AI computer model. The mechanisms receive a regulation electronic document that comprises natural language content describing a regulation and determining compliance of a monitored computing environment based on a processing of the regulation electronic document by the first trained AI computer model to generate a rule corresponding to the regulation electronic document, and application of the generated rule by the second trained AI computer model to verify compliance of the monitored computing environment.

### BACKGROUND

The present application relates generally to a data processing apparatus and method and more specifically to a computing tool and computing tool operations/functionality for validating compliance of a computing system with natural language expressed policies.

Business applications often embed business logic which is deployed to, and managed in, environments that are required to adhere to corporate policies and regulatory standards. Examples of these include applying capabilities to redact sensitive information in transit or at rest, business rules related to the pricing of products, system security policies that need to be applied to routers and corporate firewalls, and a plethora of other regulations and policies. Many banking and financial applications have requirements to comply to regulatory standards such as PCI, GDPR, ISO 27001 and NIST 800-53. These requirements, standards, and policies need to be implemented in computing solutions and, in the case of corporate policies and regulatory requirements, need to be checked continuously for compliance. Such checking may involve evidence collection, identification of gaps in compliance, and addressing these gaps when found.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises executing a first machine learning training process to train a first artificial intelligence (AI) computer model to generate rules from natural language content, to thereby generate a first trained AI computer model. The method also comprises executing a second machine learning training process to train a second AI computer model to verify compliance of a monitored computing environment with rules generated by the first AI computer model, to thereby generate a second trained AI computer model. The method further comprises receiving a regulation electronic document that comprises natural language content describing a regulation and determining compliance of a monitored computing environment based on a processing of the regulation electronic document by the first trained AI computer model to generate a rule corresponding to the regulation electronic document, and application of the generated rule by the second trained AI computer model to verify compliance of the monitored computing environment. Moreover, the method comprises outputting a result of determining compliance of the monitored computing environment.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a smart regulation system (SRS) in accordance with one illustrative embodiment; and

FIG. 3 presents a flowchart outlining example operations of a SRS in accordance with one or more illustrative embodiments.

### DETAILED DESCRIPTION

The illustrative embodiments provide an improved computing tool and improved computing tool operations/functionality for validating compliance of a computing system with natural language expressed policies.

Many software applications and platforms derive and embed logic in code based on organization regulations, standards, and policies, such as business rules, security standards, privacy requirements, and the like. Organizations are increasingly adopting computing systems, platforms, and architectures to support complex processes, which may involve many different vendors and providers, such as in a microservices architecture, cloud computing architecture, or the like, which may span many different regions or even industries. As a result, it becomes much more complex to ensure compliance with all the varied regulations, standards, and policies governing the organization and its computing systems. Such compliance checking requires a significant amount of manual effort and coordination between different teams, e.g., business analysts, regulators, developers, etc., which is fraught with errors, inefficiencies, and delays.

Moreover, regulations, standards, and policies are distributed to organizations in natural language document form as they are intended for human consumption. Thus, the process of continuously checking for compliance with regulations, standards, and policies further requires human interpretation of these organization regulations, standards and policies, and implementing them in the computer software systems of the organization, which can be a challenge for organizations. Human interpretation can result in errors as human beings interpret language differently based on their own experiences and understanding. This can be especially true when regulations, standards, and policies are generated in one geopolitical region, having its own language, customs, and the like, and these regulations, standards, and policies are interpreted by others in a different geopolitical region having a different language, customs, and the like.

Thus, it would be beneficial to eliminate the human factor in performing continuous compliance checking of complex computing systems so as to eliminate the sources of error, inefficiency, and delays and provide more consistent interpretation and application of the regulations, standards, and policies across geopolitical regions. However, in order to provide an automated computing system that eliminates the human factor, a number of issues must be addressed. For example, one issue is how to interpret these regulations, standards, and policies, described in natural language documentation, so as to transform them into a form that can be seamlessly transformed into executable code. A second issue is how an automated computing system can programmatically validate computing system compliance to these regulations, standards, and policies via validation tests based on code generated from these regulations, standards, and policies expressed in natural language.

The illustrative embodiments provide a computing tool and computing tool operations/functionality to address these issues. The computing tool and computing tool operations/functionality of the illustrative embodiments provide an artificial intelligence (AI) computer system architecture, also referred to herein as a smart regulation system (SRS), that interprets organization regulations, standards, and policies described in natural language documentation, translates these descriptions in natural language into a form of structured pseudocode, and generates rule validation tests to assist in mitigating risks of impacts to organization computing system performance.

The SRS comprises an AI rule generating engine and an AI rule validation engine, along with monitoring, auditing, and third party verification mechanisms. In one or more illustrative embodiments, the AI based engines may be implemented with machine learning trained generative transformer models. The SRS workflow leverages multiple sources of unstructured content, e.g., natural language content, directed to regulations, standards, and policies for a particular subject matter area, organization, industry, computing systems, or the like. The unstructured content may be dynamic content that is updated in real time. This unstructured content is processed and interpreted by the SRS to generate a set of rules for security and compliance verification and validation, which may be likewise performed dynamically on a periodic or continuous basis.

The SRS provides mechanisms and methodologies that generate pseudocode that represents the regulations, standards, and policies (hereafter referred to collectively as “regulations” but is intended to cover any rules of governance and compliance) which are expressed in natural language. The pseudocode represents compliance verification and validation tests/checks for computer applications that implement, and are expected to comply with, the regulations. In some illustrative embodiments, the pseudocode is translated into executable code that is specific to a particular monitored environment or computing system based on various implementation factors such as geopolitical region, computing system characteristics, organization type, environment factors, date/time, and the like. In some illustrative embodiments, the conversion of the regulations into pseudocode and then executable code may be based on a subset of the regulations determined to be applicable against a particular geopolitical region, computing system type, organization type, environment factors, date/time, or the like.

In this way, the SRS provides for dynamic fitting of regulation enforcement pseudocode and executable code into a computing environment, geopolitical region, organization, or other domain as needed in an automated manner. Moreover, the SRS operations may be performed dynamically as updates are made to regulations rather than having to have hard-coded mappings between regulation files and rules, which leads to reduced maintenance costs. The SRS operations are automated and take advantage of the power of AI and generative transformer models, thereby eliminating the many sources of human error, inefficiency, and delays present in manual solutions.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a smart regulation system (SRS) having a plurality of artificial intelligence (AI) computer models that operate to generate pseudocode and/or executable code for implementing regulations in an automated manner for monitoring, auditing, and verifying compliance of computing systems. The improved computing tool implements mechanism and functionality, such as the AI computer models, which in some embodiments may be generative transformer models, and their corresponding functionalities, which cannot be practically performed by human beings either outside of, or with the assistance of, a technical environment, such as a mental process or the like. The improved computing tool provides a practical application of the methodology at least in that the improved computing tool is able to automatically translate natural language expressed regulations into pseudocode and then translate the pseudocode into executable code for automatic checking of computing systems for compliance with the regulations.

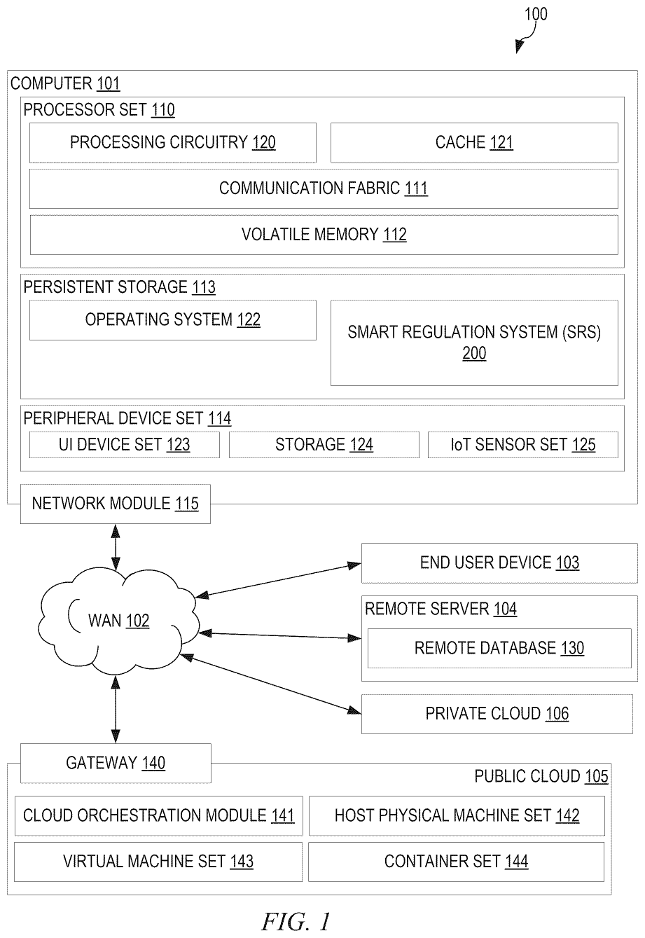

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as smart regulation system (SRS) 200. In addition to SRS 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and SRS 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in SRS 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in SRS 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a SRS 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated translation of natural language regulations into computer executable code that is executed to check compliance of monitored systems and environments.

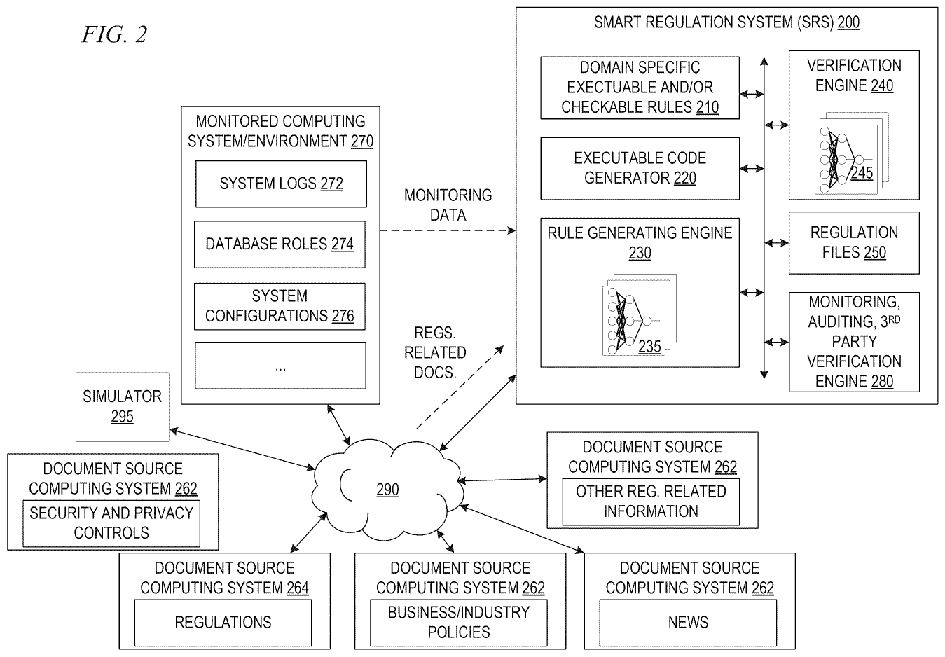

FIG. 2 is an example block diagram illustrating the primary operational components of a smart regulation system (SRS) in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that compliance with regulations is actually checked with regard to monitored computing systems or environments, and to providing an artificial intelligence (AI) based computing tool that automatically translates natural language expressed regulations into pseudocode and executable code for execution to check a monitored computing system or computing environment for compliance with the natural language expressed regulations, which cannot be practically performed by human beings as a mental process and is not directed to organizing any human activity.

As shown in FIG. 2, the SRS 200 includes domain specific executable and/or checkable rules 210, an executable code generator 220, a rule generating engine 230 having a rule generating engine AI model 235, and a verification engine 240 having a verification engine AI model 245. During a model training phase of operation, for performing machine learning training of the models 235 and 245, the SRS 200 receives input from regulation files 250, which is a set of existing regulation electronic documents describing a set of regulations in natural language content of the electronic documents. These regulation files 250 serve as training data for training the models 235 and 245. The training data may comprise a volume of natural language documents, or portions of documents, from one or more source computing systems (not shown) which are concerned with the specification and/or description of regulations applicable to a particular organization, industry, or other subject of interest for the implementation of the SRS, e.g., if the industry is the airline industry, then documentation regarding regulations governing aspects of the airline industry may be the basis of the training examples. The training examples may be labeled by subject matter experts with ground truth labels specifying the correct output of a machine learning computer model that should be generated if the machine learning computer model is trained appropriately. The simulator 295 can provide synthetic data (rules) based on training examples, to help train the rule generating model 235 and as inputs for verification engine model 245.

These training examples are input to the particular machine learning computer model, which operates on them to generate an output, and the output is then compared to the ground truth label for that example to determine a loss. Operating parameters of the machine learning computer model may then be adjusted in accordance with a machine learning training algorithm, so as to reduce the loss, and the process is then repeated until a convergence criterion is reached, e.g., a predetermined number of iterations, the loss reaching or falling below a predetermined threshold, or the like. In the present case, the ground truth labels may represent rules that should be generated from the corresponding natural language document, which may be represented as a natural language embedding, vector representation, etc. and the loss may be determined using any suitable vector similarity analysis, distance metric, or the like.

Similar machine learning training can be performed with regard to both model 235 and model 245, but with different training data. For example, while model 235 is trained on training data to produce pseudocode and/or executable code in the form of rules, the model 245 is trained to verify a monitored computing system or environment for compliance with these rules. Thus, the training data used to train the model 245 may comprise training examples of system logs, database roles, system configurations, and other pertinent data describing the configuration, architecture, and functionality of the computing system/environment. The training of the model 245 may utilize a set of computer executable rules as a basis for the machine learning training as well as the training examples, and the ground truth labels of the training examples may indicate the appropriate output that model 245 should generate based on the training rules and the training example.

In some illustrative embodiments, the models 235 and 245 may be generative transformer models or generative pre-trained (GPT) models. The models 235 and 245 utilize a transformer architecture, which is comprised of a series of encoder and decoder layers, with the decoder layers producing output text and the encoder layers processing the text that is input to the encoder layer. With a GPT model, for example, the GPT model is already pre-trained to some extent using a more general training corpus that is voluminous and covers a wide range of subject matter, much of which may have nothing to do with regulations or ensuring compliance of computing systems/environments with applicable regulations. When pre-training the GPT model, a large volume of textual data is gathered from several sources, with the larger and more diverse the data the better the outputs that are generated by the resulting GPT model. That data is cleaned and pre-processed to remove extraneous data that may cause the transformer model to generate incorrect or lower quality results, e.g., punctuation, special characters, hypertext markup language (HTML) elements, and the like, and to break down the text into chunks that are more easily processed by the transformer model.

Having gathered the data and cleaned and pre-processed the data, the transformer model is then trained to predict text in a portion of natural language content given the portion of natural language content as context. That is, a random text is removed from the portion of natural language content and, given the surrounding content, the transformer model predicts what the missing text should be. This process may be performed repeatedly using various omissions of text so as to train the transformer model to accurately predict text given a context of natural language content. Thereafter, given a context, the resulting GPT model can predict an output of natural language text that is relevant to that context.

Once trained in this manner, the generative transformer model is pre-trained and thus, is a GPT model. The GPT model may then be fine-tuned trained for a given purpose. For example, with regard to the illustrative embodiments, the model 235 may be fine-tuned, through a subsequent machine learning training process, for generating rules from regulation document inputs and the model 245 may be fine-tuned for evaluating information about a monitored computing system/environment and evaluating compliance of the monitored computing system/environment with regulations represented by a set of rules, such as those generated by the model 235. With regard to the rule generating engine AI model 235, the model 235 is fine-tune trained to generate rules, such as in the form of pseudocode rules, from regulation document inputs, where the pseudocode rules may specify inputs, criteria or conditions to be evaluated, and corresponding actions. With regard to the verification engine AI model 245, the model 245 is fine-tune trained to generate verification results from the application of rules to input features representing characteristics of a monitored computing system/environment, which may be the generation of verification metrics, identification of gaps, and/or the like.

The fine-tune training of a pre-trained transformer model, such as a GPT model, utilizes a relatively smaller training dataset than that used to perform the pre-training of the transformer model, and is a training dataset that is specific to a particular task that the model 235/245 is to perform. The operational parameters of the model 235, 245 are modified as needed in accordance with a machine learning training algorithm, such as previously described above, to reduce a loss and increase the accuracy of the model 235, 245 with regard to its specific task. Thus, the fine-tuned models 235, 245 comprise a combination of training from the pre-training and the fine-tune training and thus, leverages capabilities of natural language output generation made possible from the pre-training, and the accuracy for a particular task made possible by the fine-tune training.

After the models 235, 245 are fine-tuned, their performance may be evaluated to ensure that they perform satisfactorily for their corresponding tasks. This performance valuation may comprise using a testing dataset, similar to the training dataset, which is input to the fine-tuned model 235, 245 and the output generated is evaluated against a ground truth to determine whether the fine-tuned model 235, 245 performs its given task with a satisfactory accuracy and/or other performance metrics.

Once the models 235, 245 have been fine-tuned trained and evaluated to determine that they satisfactorily perform their corresponding tasks, the models 235, 245 may be deployed in a production environment for runtime operation and processing of new inputs. In particular, the rule generating engine AI model 235 is deployed to the rule generating engine 230 to generate rules, which may be expressed as pseudocode, based on regulation related natural language documents as inputs, which are then translated into executable code by the rule generating engine 230. The verification engine AI model 245 is deployed to the verification engine 240 to generate verification results based on various information about monitored computing systems/environments and applicable rules as inputs. The verification results may be used by the verification engine 240 to generate recommendations, notifications, and alerts to monitoring, auditing, and third party verification engine 280 as well as provide reinforcement learning feedback to the rule generating engine 230.

During a runtime phase of operation, the SRS 200 receives inputs from a plurality of different sources 260-268 via one or more data networks 290, where these inputs may comprise natural language content pertinent to regulations, which are then processed by the trained models 235 and 245. The SRS 200 further receives input data from sources 272-276 of a monitored system/environment 270 whose compliance with regulations is to be verified by the verification engine 240 based on the executable domain specific rules generated by the rule generating engine 230. Verification results, identified gaps in compliance, recommendations, and notifications may be output by the verification engine 240 and provided to monitoring, auditing, and third party verification engine 280 as well as provided to the rule generating engine 230 for reinforcement learning purposes.

The domain specific executable and/or checkable rules 210 may be generated following an open group practice, such as Open Security Controls Assessment Language (OSCAL) or other pre-defined format. The rules may be expressed in terms of pseudocode specifying inputs, criteria or conditions to be evaluated, and resulting actions for different results of the evaluations

Models need to be trained, tested and even scanned for things like bias before they can be put into production. During a model training operation, a sub-set of training regulation files 250 may be used as training inputs to the regulation rules simulator 295 to generate expected domain specific executable and/or checkable rules. Simulator 295 is a synthetic data generator service coded by software engineering logic. The model will be trained by the training subset of regulation files 250 and generated rules, and be tested by another sub-set of regulation files 250 to generate rules. The rules generated based on the test sub-set are reviewed and necessary adjustments are made to the training sub-set to make sure the model achieves a desired operational performance, e.g., accuracy. If using a pre-trained LLM, for example, this step can be used for fine-tune training of the pre-trained LLM, or prompt engineering. The goal is to make sure the rule generating engine model 235 and verification engine model 245 are trained and perform according to desired operational performance goals, e.g., a desired accuracy.

The input to the simulator 295 causes the simulator 295 to generate rules from the training regulation files 250, where these rules may again be in the form of pseudocode. This simulator 295 is a synthetic data generator. As an example, the inputs for the simulator 295 are documentation sections of regulation files, and the output may be one or more rules, such as follows:

```
...
“target”: {
  “service_name”: “user-management”,
  “resource_kind”: “user”,
  “additional_target_attributes”: [ ]
},
“required_config”: {
  “and”: [
    {
      “property”: “attached_access_group”,
      “operator”: “is_true”
    }
  ]
},
...
```

The generation of the synthetic rules data by the simulator 295 is to augment rules that may be generated by the rule generating engine AI model 235 which may be used for training the AI models. This is because there may not be sufficient training examples for training AI computer models and thus, synthetic data needs to be generated to augment the training data.

The simulator 295 may generate the synthetic rules using rule templates or a defined schema representing rules that are to be used for evaluating a monitored computing system/environment 270, and populating fields of these templates or schema for the rules with specific feature information of the extracted features that are specific to the particular systems, the configuration and the environment.

In addition, the feature embeddings of the training regulation files 250 are input to the rule generating engine AI model 235 which generates a rule output. As noted above, during a training operation, this output may be compared to a ground truth, such as during fine-tune training of the model 235 which may be pre-trained, such as in the case of a GPT model, and the model 235 operational parameters updated as needed to improve performance and achieve a satisfactory loss. The resulting set of synthetic and AI model 235 generated rules may be expressed as pseudocode which may then be provided to the executable code generator 220 which generates executable code from the pseudocode. The executable code from the generator 220 may be provided as input to the verification engine 240 for application or execution of the code to input features and evaluation by the verification engine AI model 245. The verification engine AI model 245 takes the executable code and executes or applies it to training input features, which may again be represented as feature embeddings, of characteristics of a monitored computing system/environment, and thereby generates an output representing a verification metric, gap identification, or the like. This may be compared to a ground truth to perform machine learning fine-tuned training of the model 245.

Assuming a pre-trained model, such as a GPT model, being used for models 235, 245, during the training phase of operation, the models 235 and 245 are fine-tune trained based on a determined and selected domain/industry specific executable rule language or pseudocode tool format/specification. The training data used to train these models may include natural language prompts and rule language or pseudocode depending on the target format or specification. When sufficient training data is not available the simulator 295 may be used to generate synthetic rules data based on the feature embeddings extracted from the regulation files. Using the synthetic and/or existing training data, the models 235 and 245 are fine-tune trained to generate code in the target rule/compliance checking tool format or specification. Using natural language prompts extracted from real world regulation rules expressed in natural language, the models 235 and 245 may be evaluated/tested to make sure they have expected behavior to generate rules and evaluate compliance with these rules, respectively. If either the rules appear to be generated incorrectly or testing against simulated data fails beyond a threshold, the models 235, 245 may be retrained until a desired accuracy threshold is reached. Once satisfactory performance is verified for the models 235, 245, they are deployed into their respective engines 230 and 240 for runtime operation.

During runtime operation, the models 235 and 245 operate on regulation documents expressed in natural language so as to generate new rules, update or deprecate older rules, and the like, as the original source documentation changes. Thus, during runtime operation, a plurality of different source computing systems 260-268 provide electronic documents comprising natural language content relevant to regulations of the particular industry or subject matter of the monitored computing system/environment 270. For example, these sources may provide security and privacy control related documentation, regulation documentation, industry or organization policy documentation, news documents, and the like, which may each contain natural language content that is descriptive, to some degree, of regulations for ensuring entities are in compliance with applicable governance. The rule generating engine 230, using the fine-tuned trained rule generating engine AI model 235, generates one or more rules from these documents, updates existing rules, or the like, based on a processing of features extracted from the documents and represented as feature embeddings that are input to the model 235. The resulting rules may be in the form of pseudocode which is provided to the executable code generator 220 for generation of executable code from the pseudocode.

The executable code is provided to the verification engine 240 which executes the code on input features extracted from monitoring data collected from various sources 272-276 of a monitored computing system/environment 270. For example, these sources 272-276 may comprise system logs, database roles, system configurations, and the like. The monitoring data represents the characteristics of the monitored computing system/environment 270 with regard to architecture, configuration, and functionality. The monitoring data is processed by the verification engine 240 to extract features, perform cleaning and pre-processing, and input the extracted features, e.g., as a feature embedding, into the rule verification engine AI model 245. The rule verification engine AI model 245, having been pretrained and fine-tuned, generates verification results which may be used by the verification engine 240 to generate recommendations, notifications, or alerts. For example, the verification engine 240 may identify rules that are not satisfied by the monitoring data and thus, are indicative of non-compliance with regulations. In some cases, these specific failings, or gaps, in compliance may be correlated with a knowledge base (not show) by the verification engine 240 to thereby generate recommendations as to how the monitored computing system/environment 270 may be modified to be in compliance.

To make sure that the models 235 and 245 are functioning as desired, a governance feedback may be used to evaluate the models 235 and 245 and provide a reinforcement feedback input to the rule generating engine 230 to further train the rule generating engine AI model 235. For example, the monitoring, auditing or third (3^{rd}) party verification engine 280 may receive the output from the rule validation engine 240 and may analyze the verification results, gap identifications, recommendations, and notifications to determine if they appear to be in conformance with what the monitoring, auditing, or third party verification entities may produce.

One purpose of monitoring, auditing and verification is to make sure the mechanisms of the illustrative embodiments are operating properly. This verification process may use some of original regulation sources 262, 264 to check the target system 270, to verify if the rule generation engines 230: (1) have all regulation rules captured and verified correctly; (2) determine if any rules are missed; (3) determine if rules are generated incorrectly; and (4) determine if any “un-necessary” rules are added. The verification also verifies that the verification engine 240: (1) correctly generates notifications and correctly gives recommendations; (2) does not generate false alarms; (3) does not miss verifications; and (4) does not generate incorrect recommendations. If operations are determined to be less than desired, training data for training the models may be adjusted and the models retrained as necessary to improve the operations to be within desired verification criteria.

The reinforcement learning output from the engine 280 may be provided to the rule generating engine 230 as further training examples. It should be appreciated that in some illustrative embodiments, the engine 280 may provide an interface through which a subject matter expert (SME) or other authorized personnel may manually validate and provide reinforcement feedback to the rule generating engine 230 based on the output of the rule validation engine. In this way, a periodic or continuous retraining of the rule generating engine 230 is made possible to ensure that it is operating properly when generating rules based on regulation documentation inputs.

Thus, the illustrative embodiments provide an automated AI based computing tool and corresponding functionality to automatically generate computer executable rules from natural language content descriptions of regulations governing a particular type of computing system/environment. The illustrative embodiments further provide an automated AI based computing tool and functionality for verifying compliance of a monitored computing system/environment with regard to the automatically generated executable rules and provide an output comprising information regarding verification results, gaps, recommendations, notifications, alerts, or the like. The illustrative embodiments eliminate the many sources of potential error in human based approaches and provide an ability to dynamically and automatically adapt compliance verification when new regulations or modifications to regulations are distributed.

Consider an application for a financial institution that is being migrated to a cloud environment. One of the non-functional requirements from the banking industry is continuous compliance to industry security standards such as NIST 800-53.NIST Special Publication 800-53 Revision 5-Security and Privacy Controls for Information Systems and Organizations, is a standard for security compliance policies adopted by various Information Technology (IT) departments, and in particular those operating in regulated industries such as financial services. This standard represents the regulation files or training inputs to the SRS 200 in FIG. 2. The NIST 800-53 standard, defines several compliance controls, with one such control being AC(2)(d) that describes information system Account Management policies in natural language, a portion of which is as follows:
“. . .
Specify:
1. Authorized users of the system;
2. Group and role membership; and
3. Access authorizations (i.e., privileges) and [Assignment: organization-defined attributes (as required)] for each account
. . . ”

Assuming a deployment of the mechanisms of one or more of the illustrative embodiments to an IBM Cloud and IBM Security and Compliance Center (SCC), for example, the SRS tool 200 may be used by the SCC for compliance scanning and verification. In this example, the domain/industry specific executable rule language may be the JavaScript Object Notation (JSON) representation of compliance rules.

An implementation of one illustrative embodiment may first use natural language processing topic analysis and named entity recognition methods to extract a set of prompts for each security control. The named entities and topic information may serve as prompts to the rule generating engine AI model 235 which is trained to interpret this domain specific standard and generate a compliance validation rule such as the one described herein below. This rule represents a specification for a rule defined in the SCC which can be used to validate compliance of a computing system deployed to the IBM Cloud and scanned by the SCC. The example rule is as follows:

```
...
“target”: {
  “service_name”: “user-management”,
  “resource_kind”: “user”,
  “additional_target_attributes”: [ ]
},
“required_config”: {
  “and”: [
    {
      “property”: “attached_access_group”,
      “operator”: “is_true”
    }
  ]
},
...
```

The above rule operates to make sure a user is clearly defined and an access group is attached to each user and verified. When the illustrative embodiments check this rule against a system 270, the verification engine 240 will make sure that all users are clearly defined and are associated with a correct access group. If not, a notification with a recommendation may be generated.

Now that there is a rule or rules generated, these rules may be tested to ensure that they perform properly. The input for testing these rules may be a known application deployed to the cloud environment with intentional compliance faults injected or a synthetic data such as logs or virtual private clouds and server instances profile data representing that of a real environment. Thus, during testing, the existing computing system/environment or synthetic data may be scanned with the rules deployed to the verification engine 240 and verification engine AI model 245. If the testing results are not within an expected threshold, then the models 235, 245 may be re-evaluated and retrained; otherwise, if the testing results are satisfactory, the computer executable rules are deployed for use by the verification engine 240 to verify compliance of monitored computing systems/environments 270.

Part of the deployment is to be able to continuously keep the generated rules updated, which involves continuously monitoring the sources of regulation documentation 260-268, e.g., the URL to the NIST standard. In response to detecting a change in the source 260-268, the generation of a new set of regulation based rules may be triggered using the newly updated documentation from the changed sources 260-268.

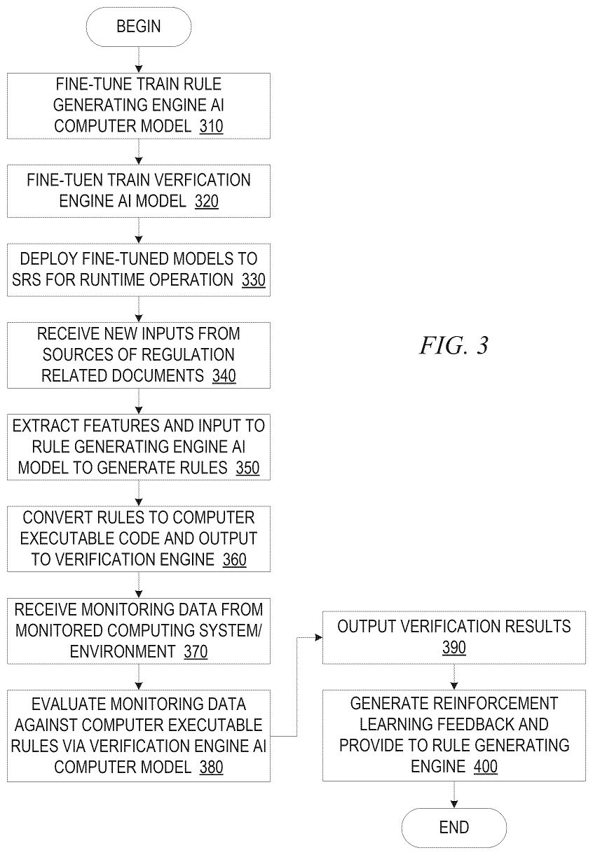

FIG. 3 presents a flowchart outlining example operations of a SRS in accordance with one or more illustrative embodiments. It should be appreciated that the operations outlined in FIG. 3 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 3, and may, in some cases, make use of the results generated as a consequence of the operations set forth in FIG. 3, the operations in FIG. 3 themselves are specifically performed by the improved computing tool in an automated manner.

The operation in FIG. 3 assumes that the AI computer models of the SRS are already pre-trained transformer computer models, such as GPT computer models. As shown in FIG. 3, the operation starts by fine-tune training a rule generating engine AI computer model for generation of pseudocode specified rules from regulation documents (step 310). In addition, the operation comprises performing fine-tuned training of a verification engine AI model for generating verification outputs based on computer executable rules generated from regulation documents and features extracted from monitoring data collected from sources in a monitored computing system/environment (step 320). The fine-tuned models are deployed to the SRS for runtime operation (step 330) and new inputs are received from sources of regulation documents (step 340). The new inputs are processed to extract features which are input to the rule generating engine AI model 235 to generate rules (step 350). The rules are converted to computer executable code and output to the verification engine (step 360). The verification engine receives monitoring data from a monitored computing system/environment (step 370) and extracts features which are input to the verification engine which evaluates the computer executable code of the regulation rules against the features extracted from the monitoring data (step 380). The verification engine outputs verification results, gap identifications, notifications, recommendations, and/or alerts based on the evaluation (step 390). The verification results are used to provide reinforcement learning back to the rule generating engine (step 400). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
executing a first machine learning training process to train a first artificial intelligence (AI) computer model to generate rules from natural language content, to thereby generate a first trained AI computer model;
executing a second machine learning training process to train a second AI computer model to verify compliance of a monitored computing environment with rules generated by the first AI computer model, to thereby generate a second trained AI computer model;
receiving a regulation electronic document that comprises natural language content describing a regulation;
determining compliance of a monitored computing environment based on a processing of the regulation electronic document by the first trained AI computer model to generate a rule corresponding to the regulation electronic document, and application of the generated rule by the second trained AI computer model to verify compliance of the monitored computing environment; and
outputting a result of determining compliance of the monitored computing environment.

2. The method of claim 1, further comprising:
receiving monitoring data from the monitored computing environment, wherein the monitoring data comprises features characterizing at least one of an architecture, configuration, or functionality of the monitored computing environment, wherein application of the generated rule by the second trained AI computer model comprises processing the monitoring data and the generated rule by the second trained AI computer model to generate an output indicating compliance or non-compliance of the monitored computing environment with the generated rule.

3. The method of claim 1, wherein the generated rule is a structured pseudocode with a rule validation test for testing compliance of a monitored computing environment with at least one condition specified in the regulation electronic document.

4. The method of claim 3, wherein generating the rule comprises translation the structured pseudocode into executable code that is specific to at least one of characteristics of the monitored computing environment or characteristics of an organization associated with the monitored computing environment.

5. The method of claim 1, wherein processing of the regulation electronic document by the first trained AI computer model to generate a rule corresponding to the regulation electronic document comprises identifying a subset of the regulation electronic document corresponding to at least one of a geopolitical region of the monitored computing environment, a computing system type of the monitored computing environment, an organization type of an organization corresponding to the monitored computing environment, and wherein the rule is generated based on the subset of the regulation electronic document.

6. The method of claim 1, wherein the first AI computer model and second AI computer model are machine learning trained generative transformer models.

7. The method of claim 1, wherein processing of the regulation electronic document by the first trained AI computer model is performed automatically and dynamically in response to at least one of the regulation electronic document being received.

8. A computer program product comprising:
one or more computer-readable storage media; and
program instructions stored on the one or more computer-readable storage media to perform operations comprising:
executing a first machine learning training process to train a first artificial intelligence (AI) computer model to generate rules from natural language content, to thereby generate a first trained AI computer model;
executing a second machine learning training process to train a second AI computer model to verify compliance of a monitored computing environment with rules generated by the first AI computer model, to thereby generate a second trained AI computer model;
receiving a regulation electronic document that comprises natural language content describing a regulation;
determining compliance of a monitored computing environment based on a processing of the regulation electronic document by the first trained AI computer model to generate a rule corresponding to the regulation electronic document, and application of the generated rule by the second trained AI computer model to verify compliance of the monitored computing environment; and
outputting a result of determining compliance of the monitored computing environment.

9. The computer program product of claim 8, wherein the operations further comprise:
receiving monitoring data from the monitored computing environment, wherein the monitoring data comprises features characterizing at least one of an architecture, configuration, or functionality of the monitored computing environment, wherein application of the generated rule by the second trained AI computer model comprises processing the monitoring data and the generated rule by the second trained AI computer model to generate an output indicating compliance or non-compliance of the monitored computing environment with the generated rule.

10. The computer program product of claim 8, wherein the generated rule is a structured pseudocode with a rule validation test for testing compliance of a monitored computing environment with at least one condition specified in the regulation electronic document.

11. The computer program product of claim 10, wherein generating the rule comprises translation the structured pseudocode into executable code that is specific to at least one of characteristics of the monitored computing environment or characteristics of an organization associated with the monitored computing environment.

12. The computer program product of claim 8, wherein processing of the regulation electronic document by the first trained AI computer model to generate a rule corresponding to the regulation electronic document comprises identifying a subset of the regulation electronic document corresponding to at least one of a geopolitical region of the monitored computing environment, a computing system type of the monitored computing environment, an organization type of an organization corresponding to the monitored computing environment, and wherein the rule is generated based on the subset of the regulation electronic document.

13. The computer program product of claim 8, wherein the first AI computer model and second AI computer model are machine learning trained generative transformer models.

14. The computer program product of claim 8, wherein processing of the regulation electronic document by the first trained AI computer model is performed automatically and dynamically in response to at least one of the regulation electronic document being received.

15. A computer system comprising:
a processor set;
one or more computer-readable storage media; and
program instructions stored on the one or more computer-readable storage media to cause the processor set to perform operations comprising:
executing a first machine learning training process to train a first artificial intelligence (AI) computer model to generate rules from natural language content, to thereby generate a first trained AI computer model;
executing a second machine learning training process to train a second AI computer model to verify compliance of a monitored computing environment with rules generated by the first AI computer model, to thereby generate a second trained AI computer model;
receiving a regulation electronic document that comprises natural language content describing a regulation;
determining compliance of a monitored computing environment based on a processing of the regulation electronic document by the first trained AI computer model to generate a rule corresponding to the regulation electronic document, and application of the generated rule by the second trained AI computer model to verify compliance of the monitored computing environment; and
outputting a result of determining compliance of the monitored computing environment.

16. The computer system of claim 15, wherein the operations further comprise:
receiving monitoring data from the monitored computing environment, wherein the monitoring data comprises features characterizing at least one of an architecture, configuration, or functionality of the monitored computing environment, wherein application of the generated rule by the second trained AI computer model comprises processing the monitoring data and the generated rule by the second trained AI computer model to generate an output indicating compliance or non-compliance of the monitored computing environment with the generated rule.

17. The computer system of claim 15, wherein the generated rule is a structured pseudocode with a rule validation test for testing compliance of a monitored computing environment with at least one condition specified in the regulation electronic document.

18. The computer system of claim 17, wherein generating the rule comprises translation the structured pseudocode into executable code that is specific to at least one of characteristics of the monitored computing environment or characteristics of an organization associated with the monitored computing environment.

19. The computer system of claim 15, wherein processing of the regulation electronic document by the first trained AI computer model to generate a rule corresponding to the regulation electronic document comprises identifying a subset of the regulation electronic document corresponding to at least one of a geopolitical region of the monitored computing environment, a computing system type of the monitored computing environment, an organization type of an organization corresponding to the monitored computing environment, and wherein the rule is generated based on the subset of the regulation electronic document.

20. The computer system of claim 15, wherein the first AI computer model and second AI computer model are machine learning trained generative transformer models.
